(19) United States
(12) Patent Application Publication
(10) Pub. No.: US 2012/0316946 A1
(43) Pub. Date: Dec. 13, 2012

(54) SYSTEM AND METHOD FOR DIRECT SALES WITH ENDORSEMENT REBATE COUPONS

(75) Inventor: Thomas M. Studney, River Forest, IL (US)

(73) Assignee: Sunstar Suisse SA, Etoy (CH)

(21) Appl. No.: 13/159,128

(22) Filed: Jun. 13, 2011

(51) Int. Cl. G06Q 30/00

(52) U.S. Cl. 705/14.19

(57) ABSTRACT

Methods and systems for generating coupons and rebates for end consumers and purchasers, who purchased products from a supplier in a qualifying transaction for use by their customers, are disclosed. In a typical transaction, the purchaser gives the purchased product to the end consumer. Product order/sales data corresponding to products purchased directly from the supplier by the end consumer are stored in a database and the end consumer is incentivized (e.g., with a purchase discount) to provide corresponding referral purchaser information. Subsequently, the end consumer order/sales data and corresponding referral purchaser information are retrieved and used to generate endorsement rebates for the referral purchaser.

### FIELD OF THE INVENTION

Aspects of the present invention relate to systems and methods for providing purchasing incentives, such as coupons and rebates, to end consumers and business purchasers that provide the end consumers with an endorsement of a product or service obtained from another party.

### BACKGROUND

Products, goods, and services are typically sold to a purchaser directly through a supplier, a reseller (a distributor, wholesaler, or retailer), or a combination of both. In some instances, the purchaser is the customer of the product. In other instances, the purchaser represents a business that provides products purchased from a supplier to its business customers at no cost, or otherwise endorses or recommends such products. Business purchasers offer such products or recommendations to customers in an attempt to facilitate relationships with the customers and build consumer loyalty. For example, it is common practice for dental offices in the dental industry to purchase non-prescription home-care hygiene products (i.e., toothbrushes, floss, and toothpaste) from suppliers and provide the products to dental office patients (customers) at no cost. When the business purchasers provide products purchased from suppliers to customers at no cost, suppliers benefit from product endorsement, product awareness, and trial use of product. Furthermore, such product endorsement, awareness and trial use generally influences customers to purchase replacement products and new products directly from the supplier.

Traditionally, suppliers offer coupons and/or rebates, and temporary promotion and sale prices as incentives to entice customers into purchasing the supplier's products, goods, or services. However, no such system exists that reward business purchasers who purchase supplier's products for distribution to customers for free that is based on subsequent purchase activity by such customers of products directly from the supplier.

### SUMMARY

According to one aspect, an endorsement rebate application includes modules that are executable by a processor, to generate an endorsement rebate. The endorsement rebate application includes an end consumer input module to receive end consumer input data from an end consumer, the end consumer input data comprising at least an end consumer order, the end consumer order specifying products for purchase. A coupon generation module generates a discount for the end consumer when the end consumer input data further comprises purchaser data, the purchaser data identifying a referral purchaser associated with the end consumer. The endorsement rebate application includes a payment calculation module to apply the discount to the end consumer order when the end consumer input data further comprises the purchaser data. A storage module stores the purchaser data in a database, and an endorsement rebate generation module to query the database in response to an event, to access purchaser data for the particular purchaser and generate an endorsement rebate for the purchaser, in response to the event.

According to another aspect, a method is provided for generating an endorsement rebate. The method includes receiving, at one or more processors, end consumer input data from an end consumer, the end consumer input data comprising at least an end consumer order, the end consumer order specifying products for purchase. The method also includes generating, at the one or more processors, a discount for the end consumer when the end consumer input data further comprises purchaser data, the purchaser data identifying a referral purchaser associated with the end consumer. The method includes applying, at the one or more processors, the discount to the end consumer order. The method further includes storing the purchaser data in a database. The method also includes querying the database in response to an event, at the one or more processors, to access purchaser data for the particular purchaser and generating an endorsement rebate for the purchaser, in response to the event, at the one or more processors.

According to yet another aspect, a system for generating an endorsement rebate is provided. The system includes a processor. The system is capable of executing an endorsement rebate application comprising modules executable by the processor. The endorsement rebate application includes an end consumer input module to receive end consumer input data from an end consumer, the end consumer input data comprising at least an end consumer order, the end consumer order specifying products for purchase from a supplier. A coupon generation module generates a discount for the end consumer when the end consumer input data further comprises purchaser data, the purchaser data identifying a referral purchaser associated with the end consumer. The endorsement rebate application includes a payment calculation module to apply the discount to the end consumer order when the end consumer input data further comprises the purchaser data. A storage module stores the purchaser data in a database, and an endorsement rebate generation module to query the database in response to an event, to access purchaser data for the particular purchaser and generate an endorsement rebate for the purchaser, in response to the event.

### BRIEF DESCRIPTION OF THE DRAWINGS

FIG. 1 is a block diagram of a computing environment for generating an endorsement rebate in accordance with one aspect of the present invention.

FIG. 2 is a block diagram of an endorsement rebate application according to one aspect of an endorsement rebate system.

FIG. 3 is an example end consumer order input form.

FIG. 4 is an example purchaser order input form.

FIG. 5 is a flowchart illustrating an exemplary method for generating an endorsement rebate.

FIG. 6 is a flowchart illustrating an exemplary method for generating an endorsement rebate.

### DETAILED DESCRIPTION

Aspects of the endorsement rebate system include computerized and networked methods and systems for providing rebates to business purchasers who purchase products from a supplier and give the products to end consumers of its business at no cost, or for sampling purposes that is based on subsequent product purchase activity between the business purchaser's end consumers and the supplier of the products. Another aspect of the endorsement rebate system enables the association of end consumers with business purchasers. For example, the endorsement rebate system provides the ability to identify which business purchaser referred a particular end consumer to the supplier, or which business purchaser distributed products manufactured by the supplier to a particular end consumer at no cost.

Aspects of the endorsement rebate system may further enable generating end consumer discounts, coupons, and/or rebates. For example, the endorsement rebate system may retrieve business purchaser data associated with a particular end consumer to determine whether a coupon should be generated and applied against the consumer's order total. Aspects of the endorsement rebate system may also enable generating endorsement rebates for business purchasers. For example, the endorsement rebate system may retrieve purchaser data and end consumer sales data to determine whether a business purchaser is entitled to an endorsement rebate.

In one possible implementation suppliers may financially reward purchasers who buy products from the supplier or reseller, and provide the products to end consumers at no cost through endorsement rebates automatically generated by the system. When an end consumer subsequently purchases the same or different products from the supplier (e.g. replacement products and/or additional products) and identifies a referring purchaser, the system stores and otherwise tracks the referring purchaser identification to eventually trigger an endorsement rebate that can be electronically applied to a referring purchaser account. Further, the supplier may provide a coupon to the end consumer to be applied directly to the end consumer's order. The referring or referral purchaser is the purchaser who originally provided the product at no cost to the end consumer. Hence, the system provides a mechanism to incentivize both the referring purchaser and the end consumer when no such incentive can naturally exist.

For example, dental office A (the purchaser) may purchase toothbrushes from a dental hygiene supplier S (the supplier) and subsequently provide a free toothbrush to a dental patient D (end consumer). At a later time, during a separate independent transaction, dental patient D may order the same toothbrush product directly from the dental hygiene supplier S through a web portal or other means, and include information in the order identifying a referring purchaser, dental office A. Since the dental patient D provided referring purchaser information (identified dental office D as the purchaser), the endorsement rebate system generates a coupon for dental patient D and an endorsement rebate for dental office A.

Although methods and systems are described herein in connection with a supplier related to dental hygiene products, it is contemplated that the principles and aspects described herein may be applied to any other type of business with similar transactions and parties, such as medical doctors and other health care providers, other professional services (e.g., fitness centers, beauty salons), the travel and leisure industry (e.g., airlines, hotels, and entertainment companies), restaurants, schools, government institutions, etc.

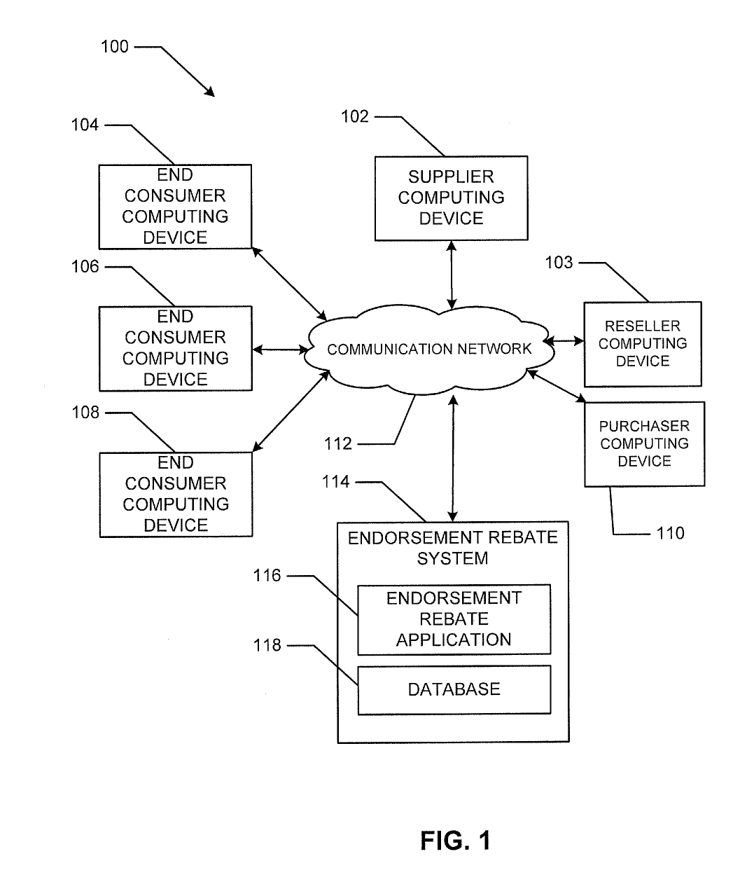

FIG. 1 is a block diagram of a computing environment 100 for generating an endorsement rebate. The computing environment 100 includes a supplier computing device 102, a reseller computing device 103, consumer computing devices 104, 106, and 108, a purchaser computing device 110, a communication network 112 and an ERS 114.

According to one aspect, each computing device depicted in FIG. 1 (e.g. the supplier computing device 102, the end consumer computing devices 104, 106, and 108, the reseller computing device 103, and the purchaser computing device 110) is a computer, a processing device, a communication device, or the like, such as a personal computer, a server computer, a tablet computer, a mobile processing device, a mobile communication device and the like. Each computing device includes one or more processors that process software or other machine-readable instructions and includes a memory to store the software or other machine-readable instructions and data. The memory may include volatile and/or non-volatile memory. Each computing device may also include a communication system to communicate via a wireline and/or wireless communications, such as through the Internet, an intranet, and Ethernet network, a wireline network, a wireless network, and/or another communication network. Each computing device may further include a display (not shown) for viewing data, such as a computer monitor, and an input device (not shown), such as a keyboard or a pointing device (e.g., a mouse, trackball, pen, touch pad, or other device) for entering data and navigating through data, including exams, images, documents, structured data, unstructured data, HTML pages, other web pages, and other data.

Each computing device communicates with the endorsement rebate system 114 via the network 112. The network 112 can be the Internet, an intranet, a local area network, a wireless local network, or another communication network, as well as combinations of networks. In another aspect, each computing device may be coupled or communicatively connected to the ERS 114 from a remote location, such as by a wide area network or via the Internet. For example, the supplier computing device 102 may communicate with the ERS 114 through a private network to generate an endorsement rebate. Furthermore, data indicative of transactions may proceed over paths that involve wire and wireless networks, both private and public. Various levels of access to the computing environment 100 may be provided through a password and user ID system.

According to one aspect, each computing device depicted in FIG. 1 (e.g. the supplier computing device 102, the consumer computing devices 104, 106, and 108, the reseller computing device 103, and the purchaser computing device 110) is associated with a particular party in a supply chain transaction for providing products to consumers. In general, a supply chain transaction refers to a system of parties, organizations, technologies, and/or resources involved in moving a product from a supplier to a consumer.

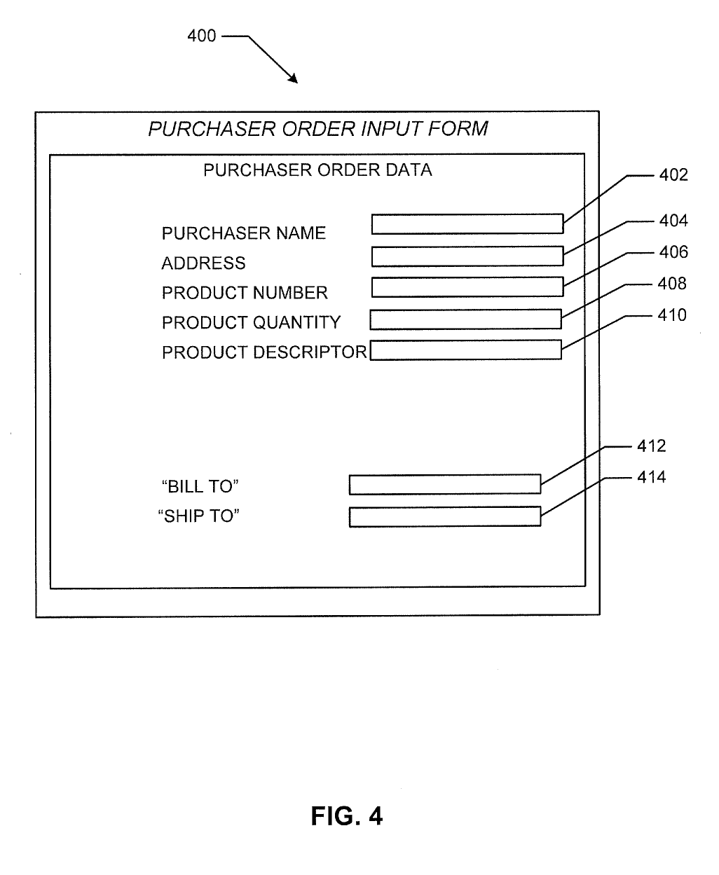

The supplier computing device 102 is associated with a supplier in the supply chain transaction. A supplier represents a person or entity that offers products for sale to purchasers under its own name or brand(s), whether the products are manufactured by the supplier or outsourced from another party. In one aspect, the supplier uses the supplier computing device 102 to generate a purchaser order data request for a purchaser such as business purchaser (e.g. dental office A) that desires to purchase a particular product directly from the supplier. The ERS 114 transmits a purchaser order data entry form to display at the supplier computing device 102 in response to the purchaser order data entry request. The supplier then uses, for example, the keyboard associated with the supplier computing device 102 to interact with the purchaser order data entry form to enter purchaser data. For example, the authorized user, such as a dental hygiene supplier sales manager, uses the supplier computing device 102 to enter the requisite purchaser data for a purchaser (e.g. dental office A) requesting to purchase products directly from the dental hygiene supplier. Purchaser data may include purchaser's name, “bill to” and “ship to” information, product number and description, and quantity ordered. After entering the business purchase data, the dental hygiene supplier sales manager uses the input device to select an input control, such as a submit control button displayed on the business purchase order data input form to transmit the business purchaser data to the ERS 114. For purposes of illustration an example purchaser data input form 400 is depicted in FIG. 4.

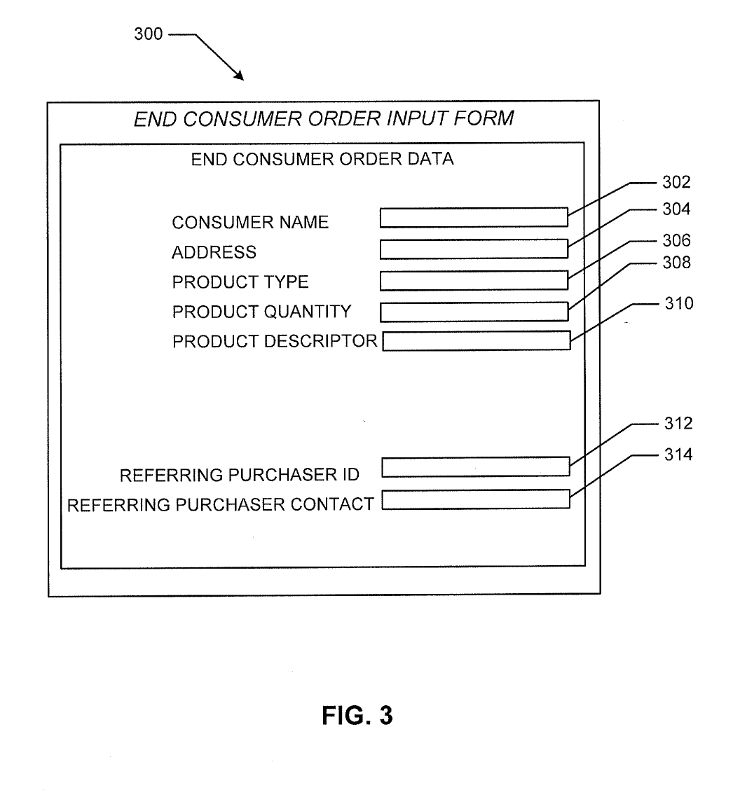

According to another aspect, the supplier may optionally use the supplier computing device 102 to generate an end consumer order data entry request for an end consumer that desires to purchase a particular product directly from the supplier. An end consumer represents a party that received free, promotional, and/or endorsed products from a purchaser, such as a business purchaser. Referring to the dental example, the dental patient D, who receives a free tooth brush from dental office A (the purchaser) is an end consumer. The ERS 114 transmits an end consumer order data entry form to display at the supplier computing device 102 in response to the end consumer order data entry request. The supplier then uses, for example, the keyboard associated with the supplier computing device 202 to interact with the end consumer order data entry form to end consumer order data. For example, the authorized user, such as a dental hygiene supplier sales manager, uses the supplier computing device 102 to enter end consumer data for an end consumer requesting to purchase products directly from the dental hygiene supplier. End consumer data may include consumer name, product description, quantity, and referral purchaser information. After entering the end consumer data, the supplier uses the input device to select an input control, such as a submit control button displayed on the end consumer order data input form to transmit the end consumer data to the ERS 114. For purposes of illustration an example end consumer data input form 300 is depicted in FIG. 3.

A reseller may interact with the reseller computing device 103 to enter a purchase order comprising purchase order data for a purchaser to purchase products from a supplier. A reseller (e.g. a distributor, wholesaler, and/or dealer) represents a party in a supply chain transaction that sells products, purchased from suppliers, to purchasers. Referring to the dental example, a reseller may sell products purchased from the dental hygiene supplier S (Supplier) to the dental office A (purchaser). In this embodiment, the reseller uses the reseller computing device 103 to access a purchase order data input form for submitting business purchaser order data. The reseller computing device 103 operates similar to the supplier computing device 102, described above in connection with FIG. 1, when using the purchaser order data input form to enter purchase order data to transmit to the ERS 114.

The purchaser computing device 110 is associated with a purchaser in a supply chain transaction. A purchaser represents a business or other entity that purchases products sold by a supplier, or products sold through a reseller that were originally purchased from a supplier, and provides the products received from the supplier and/or reseller to an end consumer at no cost or for sampling purposes, or at a reduced price. Importantly, the purchaser is not the end user of the products the purchaser obtained from the supplier or reseller. In the dental example, the dental office A that purchases products from the dental hygiene supplier S represents a purchaser.

In one aspect, if applicable, a purchaser may use the purchaser computing device to electronically execute an agreement with a supplier to purchase the supplier's products, whether direct from the supplier or through a reseller, for sampling purposes, and not for resale. The purchaser uses the purchaser computing device 110 to generate an endorsement agreement request for entering an endorsement agreement with the supplier to transmit to the ERS 114. The ERS 114 transmits an endorsement agreement form (not shown) to display at the purchaser computing device 110 in response to the endorsement agreement request. The purchaser then uses, for example, the keyboard associated with the purchaser computing device 110 to interact with the endorsement agreement form. The purchaser uses the input device to select an input control, such as a submit control button displayed on the endorsement agreement form to transmit the agreement to the ERS 114. For example, a purchaser may be a dental office that uses the purchaser computing device 110 to enter an endorsement agreement with a supplier, such as a dental hygiene company supplier. According to another aspect, the agreement may be obtained through the supplier's website, in person by a sales representative, by email, via telephone and/or some other communication device, or by paper mail.

In another aspect, the purchaser computing device 110 may be used to enter a purchase order comprising purchase order data for a purchaser to purchase products from a supplier. In this embodiment, the purchaser uses the purchaser computing device 110 to access a purchase order data input form for submitting business purchaser order data. The purchaser computing device 110 operates similar to the supplier computing device 102, described above in connection with FIG. 1 when using the purchaser order data input form to enter purchase order data to transmit to the ERS 114.

Products purchased by a purchaser from a supplier or reseller are provided to an end consumer at no cost or for sampling purposes, or at a reduced price. An end consumer represents a party in the supply chain transaction that receives supplier products for use or consumption from a purchaser. If or when the end consumer orders the product or otherwise purchases the product directly from the supplier, the purchaser may receive an endorsement rebate while the consumer may receive a discount.

In one aspect, an end consumer may interact with the end consumer computing devices 104, 106, or 108 to enter an end consumer order including end consumer order data to purchase products directly from a supplier. For example, an end consumer may interact with the consumer computing devices 104, 106, or 108 to purchase duplicate, replacement, or additional products directly from a supplier as the products received from a purchaser for sampling purposes. The end consumer uses the consumer computing devices 104, 106 or 108 to access an end consumer order data input form for submitting consumer order data. The ERS 114 transmits an end consumer data entry form to display at the supplier computing device 102 in response to the end consumer data entry request. End consumer data includes the consumer's name, “bill to” and “ship to” information, product number and description, and referring purchaser information (e.g. the purchaser who initially dispensed the sample products to the end consumer). Other data identifying the end consumer and products purchased by the end consumer may also be included. The end consumer then uses, for example, the keyboard associated with consumer computing devices 104, 106, or 108 to interact with the end consumer order data entry form to enter consumer data.

The ERS 114 includes an endorsement rebate application 116 to generate an end consumer discount for an end consumer who orders products directly from a supplier and identifies a referral purchaser in the order. For example, the endorsement rebate application collects end consumer order data and purchaser data and when it is determined that the end consumer order data identifies a referral purchaser, the endorsement rebate application generates a discount in the form of a coupon for the end consumer. The endorsement rebate application 116 stores the end consumer order data and/or end consumer data and purchaser data in a database 118.

According to another aspect, the endorsement rebate application 116 generates an endorsement rebate for the purchaser identified in the end consumer order. A rebate is an amount paid by check, direct deposit to the purchaser's designated bank account, or by way of reduction or credit to the account receivable of a purchaser who purchases product from the supplier and not a reseller of the supplier. The rebate is a type of financial reward or sales commission to purchasers of the supplier or the supplier's resellers for influencing sales of the supplier's product to end consumers. Thus, an endorsement rebate is a rebate offered by suppliers to purchasers who endorse the supplier's products. For example, the endorsement rebate application compiles end consumer order data, by purchaser, to generate an endorsement rebate based on end consumer sales from the supplier corresponding to the purchaser.

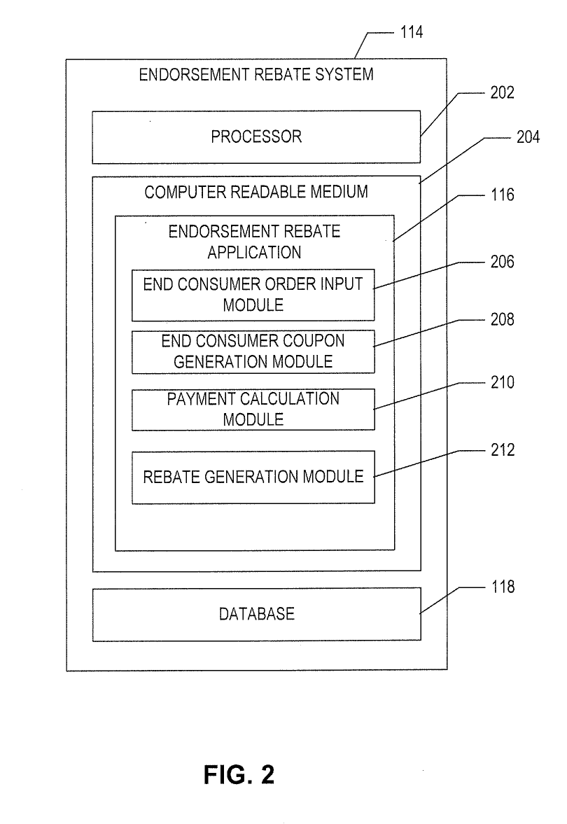

FIG. 2 is a block diagram that depicts an ERS 114 according to one example. The ERS 114 includes a processor 202 that executes the endorsement rebate application 116 to generate an end consumer coupon and/or a business purchaser rebate. The processor 202 may include memory as well as other computing components and may reside on a computer, or other processing system.

The ERS 114 may also include a computer readable media (“CRM”) 204 configured with the endorsement rebate application 114. The ERS 114 may include a database 118 to store end consumer order data and purchaser data. According to one aspect, database 118 is a general repository of consumer data, but may also include purchaser data, product data, product identification data, product specification data, test result data and/or other data relating to a product and/or the selling or manufacturing of a product. The database 118 may include memory and one or more processors or processing systems to receive, process, query and transmit communications and store and retrieve data. In another aspect, the database 118 may be a database server.

According to one aspect of the invention, the endorsement rebate application 116 includes instructions or modules that are executable by the processor 202. For example, in one embodiment, the endorsement rebate application 116 includes an end consumer order input module 206, an end consumer coupon generation module 208, a payment calculation module 210, and a rebate generation module 212. Other modules may also be included.

The end consumer order input module 206 receives consumer orders comprising end consumer order data for a particular end consumer that purchases products directly from a supplier. Products are purchased directly from a supplier when an end consumer purchases products from the supplier and no other parties are involved in the transaction. For example, the end consumer purchases the products from a supplier storefront, by mail, or electronically by email, telephone, fax, or through the supplier's website, or other websites. The end consumer order input module 206 may receive end consumer order data including product type, product quantity, end consumer name, end consumer address, end consumer contact information, and referring/referral purchaser data. Referring/referral purchaser data is data that identifies the purchaser who originally recommended or provided the end consumer with products sold by a supplier at no cost. The identified purchaser is referred to as a “referral purchaser.” In one aspect, the referral purchaser may be the same purchaser who entered purchase orders at the purchaser computing device 110, or in another aspect, entered purchaser orders at the reseller computing device 103 for the end consumer. All purchase order data of, at minimum, end consumer direct purchases, is stored in the database 118. Other end consumer data may also be received. For purposes of illustration, an example end consumer order input form is (300) is depicted in FIG. 3. As shown in FIG. 3, the end consumer order input form 300 may include an input for end consumer name 302, address 304, product type 306, product quantity 308, product descriptor 310, referring purchaser ID 312, and referring purchaser contact 314. Other data inputs may also be included.

The end consumer coupon generation module 208 generates a discount such as a coupon for a particular transaction when the end consumer order data received by the end consumer order input module 206 includes verifiable referring purchaser data. A discount refers to a reduction in the price of goods and services the end consumer must pay. Thus, a discount may be a reduction in the price an end consumer must pay for products ordered directly from a supplier. For example, in one aspect, the coupon may be an off-invoice coupon. If the end consumer provides requested referring purchaser data at the time of order from the supplier, an instant off-invoice coupon will be processed and the corresponding value of the coupon will show as a reduction to the amount due on the end consumer's order and invoice at the time of payment. In another aspect, it is contemplated that various other types of coupons and/or discounts for a particular end consumer may be generated such as gift certificates, printable coupons, fixed amount coupons, percentage coupons, member coupons, rebates, promotional codes, free shipping coupons, sweepstakes entries, etc.

The payment calculation module 210 determines the payment a particular end consumer is going to pay for an order made to the supplier based on the discount generated for the particular end consumer by the end consumer coupon generation module 208. The discount will be applied as reduction to the end consumers total product order amount. For example, if an off-invoice coupon is generated by the end consumer coupon generation module 208, the payment calculation module 210 will reduce the particular end consumer's total order cost by the amount indicated in the off-invoice coupon. In another aspect, the coupon may be generated by the coupon generation module 208 that an end consumer can print and use at a supplier store, website, etc. In another aspect, the coupon may be stored and emailed to an end consumer with other information that an end consumer may elect to save and accumulate.

The rebate generation module 212 generates an endorsement rebate for a particular purchaser based on end consumer order data received at the end consumer order input module 206. The rebate generation module 212 queries the database 118 to retrieve end consumer orders and generates an endorsement rebate based on end consumer sales corresponding to each referral purchaser. For example, the rebate generation module 212 may query the database 118 based on an end consumer name to identify end consumer order data corresponding to the end consumer name requested. Subsequently, the rebate generation module 212 extracts any referral purchaser data found in the end consumer order data, such as the referral purchaser's identity. For example, 20 end consumer orders may be retrieved from the database 118, each identifying referral purchaser A. Based on the 20 end consumers identifying referral purchaser A, an endorsement rebate is generated for referral purchase A. The end consumer order data may be complied periodically (e.g. monthly, quarterly, yearly, etc) by the rebate generation module 212 to generate endorsement rebates. In another aspect, the end consumer order data may be compiled in response to an event, such as the occurrence of a periodic temporal interval. For example, end consumer order data my be compiled every 30 minutes, 1 hour, 24 hours, etc. As another example, end consumer order data may be compiled in response to request (the event) sent from a supplier computing device 102. As another example, end consumer order data may be compiled in response to a request from a purchaser using the purchaser computing device 110. End consumer order data may be compiled in response to meeting a referral threshold, such as when 100 end consumer orders identify a particular referral purchaser. According to yet another aspect, the rebate generation module may query the database 118 based on purchaser data such as a referral purchaser name to identify end consumer order data associated with the particular referral purchaser.

According to another aspect, there may be variations to the rebate generated. For example, using a percentage (%) of end consumer sales as a formula, there may be a higher percentage rebate total if end consumer sales reach/exceed a certain amount in a given period (e.g. $0-$50=10%; %501-$1000=12%). As another example, a limited time bonus rebate percentage may be applied to the original rebate generated for sales made during a certain time, or a flat amount may be applied to the rebate for new product sales in excess of a sale amount threshold.

In another aspect, after the endorsement rebate has been generated, the rebate generation module 212 may prepare the endorsement rebate to be issued to a particular purchaser according to instructions from each referral purchaser. For example, endorsement rebates may be issued by check, direct to a designated bank account, or if the purchaser purchases products for sampling directly from the supplier, a credit may be applied to the supplier's account receivable of the purchaser.

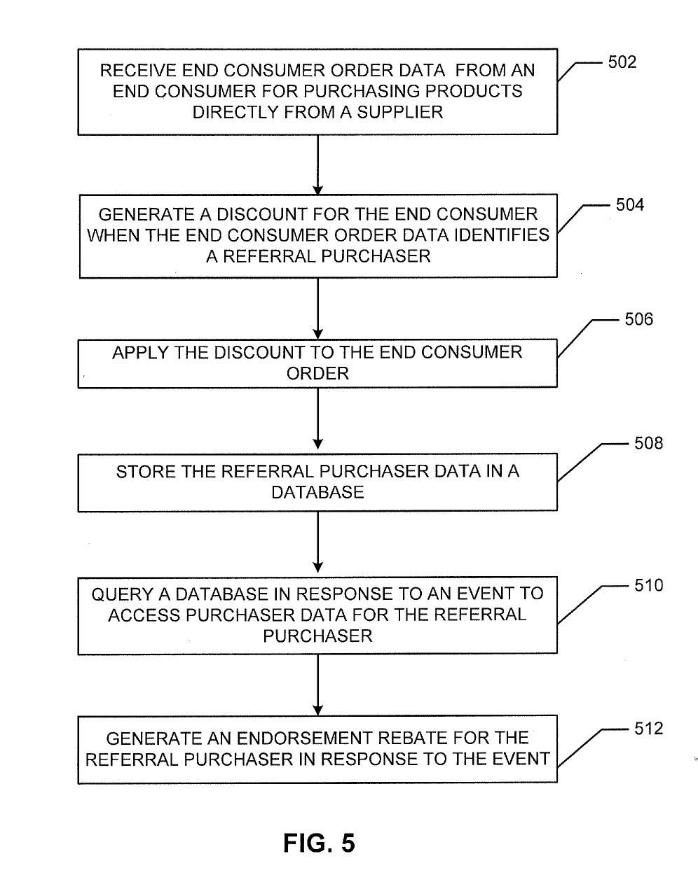

FIG. 5 depicts an example method for generating an endorsement rebate according to an example embodiment. At 502, end consumer order data for purchasing products directly from a supplier is received from an end consumer. A discount is generated for the end consumer when the end consumer order data identifies a referral purchaser at 504. At 506, the discount is applied to the end consumer order. At 508, the referral purchaser data is stored in a database. The data base is queried in response to an event to access the referral purchaser data at 510. At 512, an endorsement rebate is generated for the identified referral purchaser.

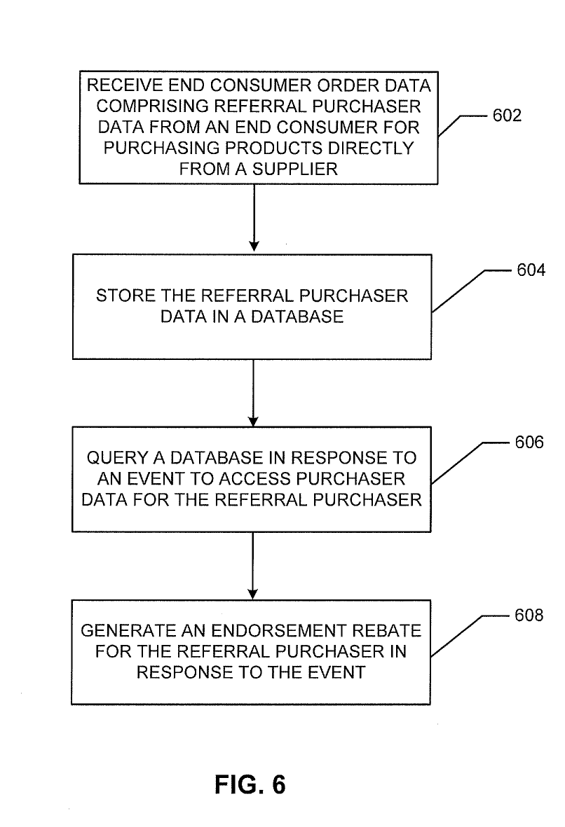

FIG. 6 depicts another example method for generating an endorsement rebate according to an example embodiment. At 602, end consumer order data comprising referral purchaser data is received from an end consumer for purchasing products directly from a supplier. The data is stored in a database at 604. The data base is queried in response to an event to access the referral purchaser data at 606. At 608, an endorsement rebate is generated for the identified referral purchaser in response to the event.

The description above includes example systems, methods, techniques, instruction sequences, and/or computer program products that embody techniques of the present disclosure. However, it is understood that the described disclosure may be practiced without these specific details.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium (e.g., floppy diskette), optical storage medium (e.g., CD-ROM); magneto-optical storage medium, read only memory (ROM); random access memory (RAM); erasable programmable memory (e.g., EPROM and EEPROM); flash memory; or other types of medium suitable for storing electronic instructions.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

Those skilled in the art will appreciate that variations from the specific embodiments disclosed above are contemplated by the invention. The following invention should not be restricted to the above embodiments, but should be measured by the following claims.

What is claimed is:

1. A method for endorsement rebate generation comprising:
receiving, at one or more processors, end consumer input data, the consumer input data comprising at least an end consumer order, the end consumer order specifying one or more products for purchase;
generating, at the one or more processors, a discount for the end consumer when the end consumer input data further comprises referral purchaser data, the referral purchaser data identifying a referral purchaser associated with the end consumer;
applying, at the one or more processors, the discount to the end consumer order; and
generating an endorsement rebate for the referral purchaser, at the one or more processors.

2. The method of claim 1 further comprising:
storing the end consumer order and the referral purchaser data in a database; and
querying the database in response to an event, at the one or more processors, to access the referral purchaser data to identify a referral purchaser.

3. The method of claim 1, wherein the referral purchaser data identifies the referral purchaser by telephone number, name, and address.

4. The method of claim 1, wherein the one or more products for purchase are purchased directly from a supplier by an end consumer.

5. The method of claim 1, further comprising sending the endorsement rebate to the referral purchaser according to an instruction indicated by the referral purchaser.

6. The method of claim 1, wherein the discount is an off-invoice coupon.

7. The method of claim 1, wherein the referral purchaser is associated with the end consumer when it is determined that the referral purchaser provided salable products sold by the supplier to the end consumer at no charge.

8. An endorsement rebate system comprising:
a processor;
an endorsement rebate application comprising modules executable by the processor, the modules comprising:
an end consumer order input module to receive end consumer input data, the consumer input data comprising at least an end consumer order, the end consumer order specifying one or more products for purchase;
an end consumer coupon generation module to generate a discount for the end consumer when the end consumer input data further comprises referral purchaser data, the referral purchaser data identifying a referral purchaser associated with the end consumer;
a payment calculation module to apply the discount to the end consumer order; and
an endorsement rebate generation module to generate an endorsement rebate for the referral purchaser, in response to the event.

9. The system of claim 8, further comprising a storage module to store the end consumer order and referral purchaser data in a database, and wherein the endorsement rebate generation module is further configured to query the database in response to an event, to access referral purchaser data for the referral purchaser.

10. The system of claim 8, wherein the referral purchaser data identifies the referral purchaser by telephone number, name, and address.

11. The system of claim 8, wherein the one or more products for purchase are purchased directly from a supplier.

12. The system of claim 8, further comprising sending the endorsement rebate to the referral purchaser according to an instruction indicated by the referral purchaser.

13. The system of claim 8, wherein the discount is an off-invoice coupon.

14. The system of claim 8, wherein the referral purchaser is associated with the end consumer when it is determined that the referral purchaser provided salable products sold by the supplier to the end consumer at no charge.

15. A computer-readable medium encoded with an endorsement rebate application comprising modules executable by a processor comprising:
an end consumer order input module to receive end consumer input data, the end consumer input data comprising at least an end consumer order, the end consumer order specifying one or more products for purchase;
an end consumer coupon generation module to generate a discount for the end consumer when the end consumer input data further comprises referral purchaser data, the referral purchaser data identifying a referral purchaser associated with the end consumer;
a payment calculation module to apply the discount to the end consumer order; and
an endorsement rebate generation module to generate an endorsement rebate for the referral purchaser, in response to the event.

16. The computer-readable medium of claim 15 further comprising a storage module to store the end consumer order and referral purchaser data in a database, and wherein the endorsement rebate generation module is further configured to query the database in response to an event, to access referral purchaser data for the referral purchaser.

17. The computer-readable medium of claim 15, wherein the purchaser data identifies the referral purchaser by telephone number, name, and address.

19. The computer-readable medium of claim 15, further comprising sending the endorsement rebate to the referral purchaser according to an instruction indicated by the referral purchaser.

20. The computer-readable medium of claim 15, wherein the discount is an off-invoice coupon.

21. The computer-readable medium of claim 15, wherein the referral purchaser is associated with the end consumer when it is determined that the referral purchaser provided salable products sold by the supplier to the end consumer at no charge.
